(19) United States
(12) Patent Application Publication
(10) Pub. No.: US 2022/0327803 A1
(43) Pub. Date: Oct. 13, 2022

(54) METHOD OF RECOGNIZING OBJECT, ELECTRONIC DEVICE AND STORAGE MEDIUM

(71) Applicant: Beijing Baidu Netcom Science Technology Co., Ltd., Beijing (CN)

(72) Inventors: Wei YU, Beijing (CN); Kun WANG, Beijing (CN)

(21) Appl. No.: 17/809,210

(22) Filed: Jun. 27, 2022

(30) Foreign Application Priority Data
Jun. 30, 2021 (CN) 202110734210.3

(51) Int. Cl. G06V 10/75; G06V 10/40; G06V 10/82; G06V 10/774; G06V 10/80; G06V 10/776; G06V 10/74; G06V 10/22

(52) U.S. Cl. CPC G06V 10/751; G06V 10/40; G06V 10/82; G06V 10/774; G06V 10/806; G06V 10/776; G06V 10/761; G06V 10/22

(57) ABSTRACT

A method of recognizing an object, an electronic device and storage medium are provided, which relate to a field of data processing, in particular to a field of object recognition. The method includes: acquiring a position information and an image data of an object to be detected; performing a feature extraction on the position information and the image data of the object to be detected to obtain a first target concatenating feature; inputting the first target concatenating feature into a pre-trained deep learning model to obtain a second target concatenating feature; determining a second sample concatenating feature matched with the second target concatenating feature by matching the second target concatenating feature with each second sample concatenating feature obtained by processing a first sample concatenating feature of a sample object; and determining the object to be detected as the sample object corresponding to the second sample concatenating feature.

### CROSS REFERENCE TO RELATED APPLICATION(S)

This application claims priority to Chinese Patent Application No. 202110734210.3, filed on Jun. 30, 2021, the entire content of which is incorporated herein in its entirety by reference.

### TECHNICAL FIELD

The present disclosure relates to a field of data processing technology, and in particular to a method of recognizing an object, an electronic device and a storage medium.

### BACKGROUND

In a geographic information system, a POI (Point of Interest) may be a house, a shop, a mailbox, a bus stop, etc. Recognition of POI is of great significance in user positioning, electronic map generating and so on.

### SUMMARY

The present disclosure provides a method of recognizing an object, an electronic device and a storage medium.

According to an aspect of the present disclosure, a method of recognizing an object is provided, including:

acquiring a position information and an image data of an object to be detected;

performing a feature extraction on the position information and the image data of the object to be detected, so as to obtain a first target concatenating feature, and the first target concatenating feature including a position information feature and an image data feature of the object to be detected;

inputting the first target concatenating feature into a pre-trained deep learning model, so as to obtain a second target concatenating feature;

determining a second sample concatenating feature matched with the second target concatenating feature by matching the second target concatenating feature with each second sample concatenating feature obtained by processing a first sample concatenating feature of a sample object using the deep learning model; and

determining the object to be detected as the sample object corresponding to the second sample concatenating feature matched with the second target concatenating feature.

According to another aspect of the present disclosure, an electronic device is provided, including:

at least one processor; and

a memory communicatively connected to the at least one processor, wherein the memory stores instructions executable by the at least one processor, and the instructions, when executed by the at least one processor, cause the at least one processor to implement any method of recognizing an object in the present disclosure.

According to another aspect of the present disclosure, a non-transitory computer-readable storage medium having computer instructions stored thereon is provided, wherein the computer instructions are configured to cause a computer to implement any method of recognizing an object in the present disclosure.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to better understand the scheme and do not constitute a limitation of the present disclosure, in which:

FIG. 1 shows a schematic diagram of a method of recognizing an object according to the present disclosure;

FIG. 2 shows a schematic diagram of an implementation of step S102 according to the present disclosure;

FIG. 3 shows a schematic diagram of a method of training a deep learning model according to the present disclosure;

FIG. 4 shows a schematic diagram of an apparatus of recognizing an object according to the present disclosure; and

FIG. 5 shows a block diagram of an electronic device for implementing a method of recognizing an object according to the embodiments of the present disclosure.

### DETAILED DESCRIPTION OF EMBODIMENTS

The following describes exemplary embodiments of the present disclosure with reference to the accompanying drawings, which include various details of the embodiments of the present disclosure to facilitate understanding, and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

In an embodiment of the present disclosure, a method of recognizing an object is provided, as shown in FIG. 1, the method includes operations S101 to S105.

In S101, a position information and an image data of an object to be detected are acquired.

The method of recognizing an object of the embodiments of the present disclosure may be implemented by an electronic device. Specifically, the electronic device may be a personal computer, a smart phone, a server, etc.

The object to be detected may be an object at a fixed position (or a fixed object). For example, the object to be detected may be a signboard (or brand) of a shop, a house, a bridge, a bus stop, etc. The image data of the object to be detected refers to an image including the object to be detected. The position information of the object to be detected may include a longitude and a latitude of the object to be detected, or coordinates of the object to be detected in a customized world coordinate system.

In S102, a feature extraction is performed on the position information and the image data of the object to be detected, so as to obtain a first target concatenating feature, and the first target concatenating feature includes a position information feature and an image data feature of the object to be detected.

The first target concatenating feature of the object to be detected includes the position information feature (i.e., a spatial feature) of the object to be detected and the image data feature (i.e., visual feature) of the object to be detected. In an example, the position information feature and the image data feature of the object to be detected may be extracted separately, and the position information feature and the image data feature may be concatenated to obtain the first target concatenating feature. In an example, a joint feature extraction may be performed on the position information and the image data of the object to be detected to obtain the first target concatenating feature. Specifically, the position information of the object to be detected may be used as an additional channel of the image data. For example, the image data includes three channels (R, G and B), and a channel is added on the basis of these three channels. The newly added channel corresponds to the position information of the object to be detected (in an example, a first row of the channel may correspond to an X coordinate, a second row of the channel may correspond to a Y coordinate, and other rows may be set to zero), and then the data containing four channels are input into a convolutional neural network for the feature extraction, so as to obtain the first target concatenating feature.

In S103, the first target concatenating feature is input into a pre-trained deep learning model, so as to obtain a second target concatenating feature.

The deep learning model may be any feature extraction network, such as CNN (Convolutional Neural Network), RCNN (Region-CNN) or YOLO (You Only Look Once), etc. In an example, the deep learning model may adopt MLP (Multilayer Perceptron) network.

The pre-trained deep learning model is used to process the first target concatenating feature to obtain the second target concatenating feature. The processing here may include one or more of convolution processing, pooling processing, down sampling, up sampling, residual calculation, etc. An actual processing manner is determined by an actual network structure of the deep learning model. After the processing of the deep learning model, a similarity between second target concatenating features for the same target is greater than a similarity between second target concatenating features for different targets.

In S104, a second sample concatenating feature matched with the second target concatenating feature is determined by matching the second target concatenating feature with each second sample concatenating feature obtained by processing a first sample concatenating feature of a sample object using the deep learning model.

The first sample concatenating feature of the sample object is input into the deep learning model, so that the deep learning model outputs the second sample concatenating feature of the sample object. The first sample concatenating feature of the sample object includes a position information feature and an image data feature of the sample object. The second sample concatenating feature of each sample object is obtained, and the second sample concatenating feature matched with the second target concatenating feature is obtained by matching the second target concatenating feature with each second sample concatenating feature. In an example, the second target concatenating feature may be matched with one second sample concatenating feature in one matching process. In an example, in order to improve a matching efficiency, a parallel matching may be adopted. The second target concatenating feature may be matched with a plurality of second sample concatenating features in one matching process.

In an embodiment, determining the second sample concatenating feature matched with the second target concatenating feature by matching the second target concatenating feature with each second sample concatenating feature may include: determining the second sample concatenating feature matched with the second target concatenating feature by matching the second target concatenating feature with a plurality of second sample concatenating features in parallel using a preset artificial neural network.

ANN (Artificial Neural Network) has characteristics of parallel processing and continuous calculation. By using ANN to match the second target concatenating feature with the plurality of second sample concatenating features in parallel, it is possible to match the second target concatenating feature with each second sample concatenating feature fast and accurately, which improves the matching efficiency, and further improves an efficiency of recognizing an object.

In S105, the object to be detected is determined as the sample object corresponding to the second sample concatenating feature matched with the second target concatenating feature.

A sample object to which the second sample concatenating feature matched with the second target concatenating feature belongs is called a target sample object, and the object to be detected is the target sample object.

In the embodiments of the present disclosure, the first target concatenating feature including the position information feature and the image data feature of the object to be detected is obtained based on the position information and the image data of the object to be detected. The first target concatenating feature is converted into the second target concatenating feature using the deep learning model. The second target concatenating feature is matched with the second sample concatenating feature of each sample pair, and it is determined that the object to be detected is the sample object corresponding to the second sample concatenating feature matched with the second target concatenating feature. In this way, the recognition of the object to be detected is implemented. The object to be detected may be POI, and thus the method may be applied to a recognition scene for POI. The second sample concatenating feature has both the visual feature and the spatial feature. Object matching may be achieved through one-step matching, which reduces the complexity of matching and increases the efficiency of matching so as to further improve the efficiency of recognizing an object, compared with two-step matching of the spatial feature and the visual feature respectively.

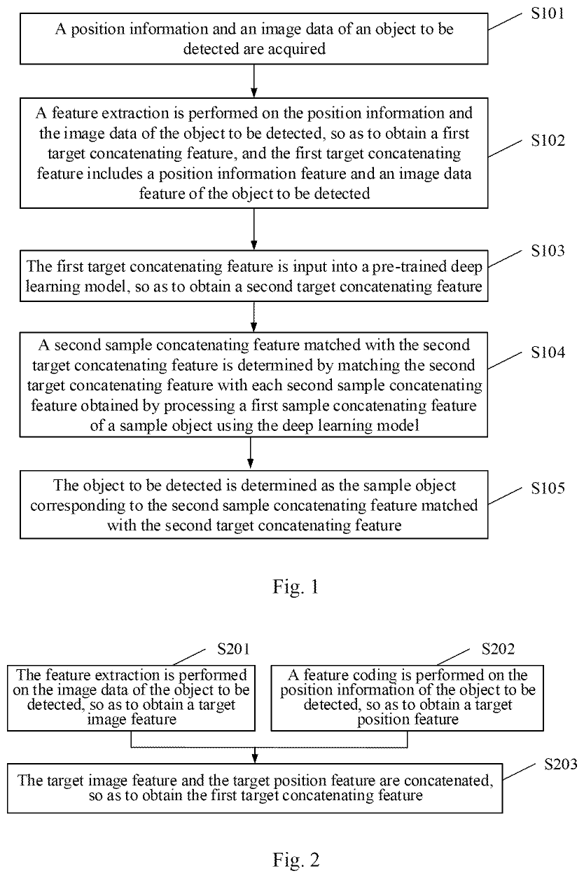

In an example, the position information feature and the image data feature of the object to be detected may be extracted separately, and then the first target concatenating feature may be obtained through a concatenating process. For example, as shown in FIG. 2, in an embodiment, performing the feature extraction on the position information and the image data of the object to be detected so as to obtain the first target concatenating feature may include: operations S201 to S203.

In S201, the feature extraction is performed on the image data of the object to be detected, so as to obtain a target image feature.

For the manner of extracting an image feature, reference may be made to the manners of extracting an image feature in related art. For example, the feature extraction may be performed on the image data of the object to be detected by using a convolutional neural network. For example, the feature extraction may be performed on the image data of the object to be detected based on a feature extraction model of Arcface. In an example, the feature extraction may also be performed on the image data of the object to be detected by using an image feature extraction operator. Specifically, the image feature extraction operator may be HOG (Histograms of Oriented Gradients) extraction operator, LBP (Local Binary Pattern) extraction operator, or Haar-like feature extraction operator, etc.

In S202, a feature coding is performed on the position information of the object to be detected, so as to obtain a target position feature.

The target image feature corresponds to the image data feature described above, and the target position feature corresponds to the position information feature described above.

In an example, the feature coding may be performed on the position information of the object to be detected by using a preset spatial coding method, such as Geohash coding algorithm or one-hot coding algorithm, so as to obtain the target position feature of the object to be detected.

In the embodiments of the present disclosure, the implementation order of S201 and S202 is not limited. S201 may be implemented before S202, 5201 may be implemented after S202, and S201 and S202 may be implemented in parallel, which are all within the protection scope of the present application.

In S203, the target image feature and the target position feature are concatenated to obtain the first target concatenating feature.

In an example, the target image feature and the target position feature of the object to be detected may be directly added in dimension to obtain the first target concatenating feature. In an example, a concat( ) function may be called to concatenate the target image feature and the target position feature of the object to be detected, so as to obtain the first target concatenating feature.

In the embodiments of the present disclosure, the position information feature and the image data feature of the object to be detected are extracted separately, so as to obtain the first target concatenating feature through the concatenating process, which achieves a combination of the spatial feature and the visual feature of the object to be detected simply and efficiently. Subsequently, the object to be detected may be recognized by one-time matching based on the first target concatenating feature including the spatial feature and the visual feature of the object to be detected, so that the efficiency of recognizing the object is high.

The deep learning model needs to be trained in advance. In an embodiment, the above-mentioned methods further includes following steps.

In step 1, a plurality of sample pairs are acquired. The plurality of sample pairs include a plurality of first type negative sample pairs, a plurality of second type negative sample pairs, and a plurality of positive sample pairs. The first type negative sample pair includes first sample concatenating features of two sample objects with the same signboard and having a distance greater than a preset distance threshold therebetween. The second type negative sample pair includes first sample concatenating features of two sample objects with different signboards and having a distance less than the preset distance threshold therebetween. The positive sample pair includes first sample concatenating features of two sample objects with the same signboard and having a distance less than the preset distance threshold therebetween.

In step 2, a sample pair is selected from the plurality of sample pairs, and first sample concatenating features of the sample pair are input into the deep learning model for processing, so as to obtain two second sample concatenating features corresponding to the sample pair.

In step 3, a loss of the deep learning model is calculated based on a similarity between the two second sample concatenating features corresponding to the sample pair, and a training parameter of the deep learning model is adjusted according to the current loss. For the first type negative sample pairs and the second type negative sample pairs, the higher the similarity between two corresponding second sample concatenating features, the greater the loss of the deep learning model. For the positive sample pair, the higher the similarity between two corresponding second sample concatenating features, the smaller the loss of the deep learning model.

In step 4, it is determined whether a preset end condition is met or not. If a preset end condition is not met, a sample pair is selected from the plurality of sample pairs, and two first sample concatenating features of the sample pair are input into the deep learning model for processing, so as to obtain two second sample concatenating features corresponding to the sample pair, and then proceed to the following steps. If the preset end condition is met, a trained deep learning mode is obtained.

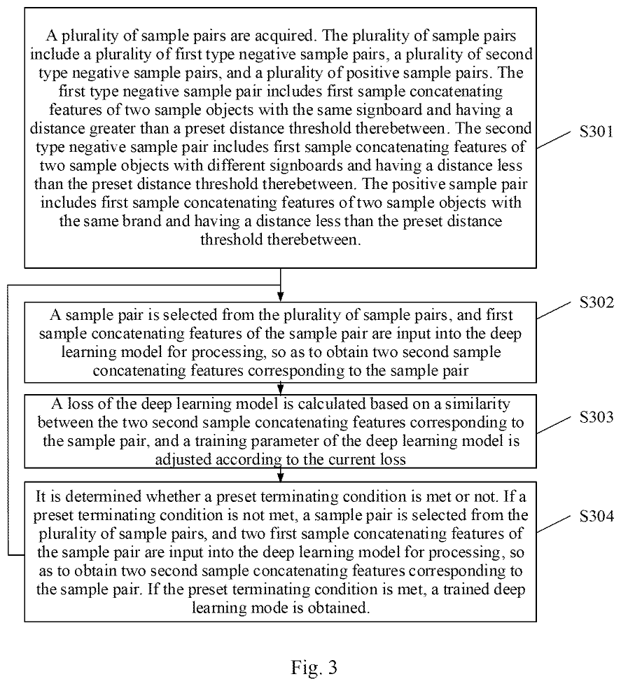

According to the embodiments of the present disclosure, a method of training a deep learning model is further provided. As shown in FIG. 3, the method includes operations S301 to S304.

In S301, a plurality of sample pairs are acquired. The plurality of sample pairs include a plurality of first type negative sample pairs, a plurality of second type negative sample pairs, and a plurality of positive sample pairs. The first type negative sample pair includes first sample concatenating features of two sample objects with the same signboard and having a distance greater than a preset distance threshold therebetween. The second type negative sample pair includes first sample concatenating features of two sample objects with different signboards and having a distance less than the preset distance threshold therebetween. The positive sample pair includes first sample concatenating features of two sample objects with the same signboard and having a distance less than the preset distance threshold therebetween.

In an example, two sample objects with the same signboard and having a distance greater than the preset distance threshold therebetween are selected. For any one of the two sample objects, a feature extraction is performed on the position information and the image data of the sample object to obtain a first sample concatenating feature of the sample object, so as to obtain the first sample concatenating features of the two sample objects to form the first type negative sample pair.

In an example, two sample objects with different signboards and having a distance less than the preset distance threshold therebetween are selected. For any one of the two sample objects, a feature extraction is performed on the position information and the image data of the sample object to obtain a first sample concatenating feature of the sample object, so as to obtain the first sample concatenating features of the two sample objects to form the second type negative sample pair.

In an example, two sample objects with the same signboard and having the distance less than the preset distance threshold therebetween are selected. For any one of the two sample objects, a feature extraction is performed on the position information and the image data of the sample object to obtain a first sample concatenating feature of the sample object, so as to obtain the first sample concatenating features of the two sample objects to form the positive sample pair.

For a specific implementation process of “performing the feature extraction on the position information and the image data of the sample object, so as to obtain the first sample concatenating feature of the sample object”, reference may be made to the specific implementation process of “performing the feature extraction on the position information and the image data of the object to be detected, so as to obtain the first target concatenating feature” in the embodiment above, which will not be repeated here.

In S302, a sample pair is selected from the plurality of sample pairs, and first sample concatenating features of the sample pair are input into the deep learning model for processing, so as to obtain two second sample concatenating features corresponding to the sample pair.

The deep learning model may be any feature extraction network, such as CNN (Convolutional Neural Network), RCNN (Region-CNN) or YOLO (You Only Look Once), etc. In an example, the deep learning model may adopt MLP (Multilayer Perceptron) network.

In S303, a loss of the deep learning model is calculated based on a similarity between the two second sample concatenating features corresponding to the sample pair, and a training parameter of the deep learning model is adjusted according to the current loss. For the first type negative sample pairs and the second type negative sample pairs, the higher the similarity between two corresponding second sample concatenating features, the greater the loss of the deep learning model. For the positive sample pair, the higher the similarity between two corresponding second sample concatenating features, the smaller the loss of the deep learning model.

A goal of training the deep learning model is to minimize the similarity between the two second sample concatenating features obtained based on the same negative sample pair (including the first type negative sample pair and the second type negative sample pair) and maximize the similarity between the two second sample concatenating features obtained based on the same positive sample pair. The loss of the model may be a metric loss, such as triplet loss or npair loss, or a classification loss with metric, such as arcface or sphereface.

In S304, it is determined whether a preset end condition is met or not. If a preset end condition is not met, a sample pair is selected from the plurality of sample pairs, and two first sample concatenating features of the sample pair are input into the deep learning model for processing, so as to obtain two second sample concatenating features corresponding to the sample pair, and then proceed to the following steps. If the preset end condition is met, a trained deep learning mode is obtained.

The preset end condition may be customized according to an actual situation, for example, the preset end condition may include the loss convergence of the model, or may include reaching a preset number of training times, etc.

In an example, the deep learning model may be trained by randomly selecting the first type negative sample pair, the second type negative sample pair or the positive sample pair.

In an example, in order to accelerate the training of the deep learning model, the deep learning model may be trained by selecting the first type negative sample pair and the positive sample pair, so as to complete a distinguishing training of the deep learning model in the spatial dimension. Then, the deep learning model is trained by selecting the second type negative sample pair and the positive sample pair, so as to complete a distinguishing training of the deep learning model in the visual dimension.

In an example, in order to accelerate the training of the deep learning model, the deep learning model may be trained by selecting the second type negative sample pair and the positive sample pair, so as to complete a distinguishing training of the deep learning model in the visual dimension. Then, the deep learning model is trained by selecting the first type negative sample pair and the positive sample pair, so as to complete a distinguishing training of the deep learning model in the spatial dimension.

In the embodiments of the present disclosure, a method of training the deep learning model is provided, which may be applied to the recognition scene for POI. The feature conversion of the deep learning model is based on both the visual feature and the spatial feature. Then, object matching may be achieved through one-step matching, which reduces the complexity of matching and increases the efficiency of matching so as to further improve the efficiency of recognizing an object, compared with two-step matching of the spatial feature and the visual feature respectively.

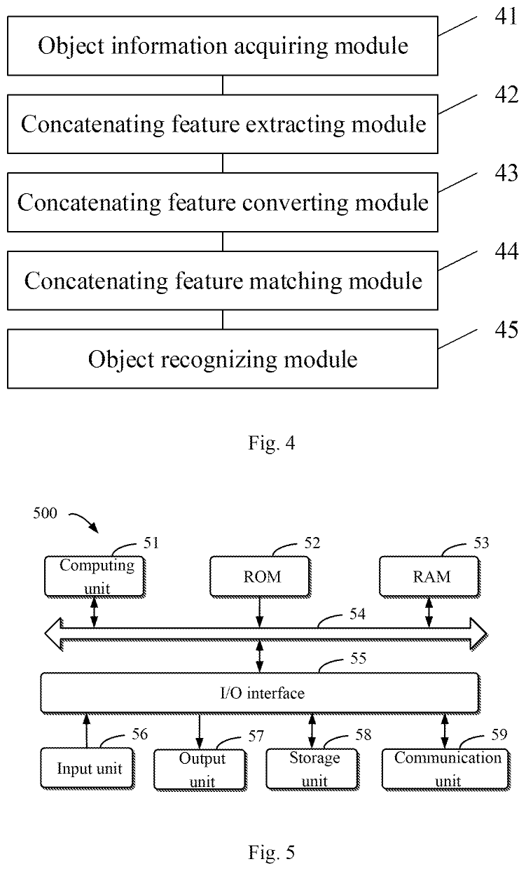

According to the embodiments of the present disclosure, an apparatus of recognizing an object is further provided, as shown in FIG. 4, including an object information acquiring module 41, a concatenating feature extracting module 42, a concatenating feature converting module 43, a concatenating feature matching module 44, and an object recognizing module 45.

The object information acquiring module 41 is used to acquire a position information and an image data of an object to be detected.

The concatenating feature extracting module 42 is used to perform a feature extraction on the position information and the image data of the object to be detected, so as to obtain a first target concatenating feature, and the first target concatenating feature includes a position information feature and an image data feature of the object to be detected.

The concatenating feature converting module 43 is used to input the first target concatenating feature into a pre-trained deep learning model, so as to obtain a second target concatenating feature.

The concatenating feature matching module 44 is used to determine a second sample concatenating feature matched with the second target concatenating feature by matching the second target concatenating feature with each second sample concatenating feature obtained by processing a first sample concatenating feature of a sample object using the deep learning model.

The object recognizing module 45 is used to determine the object to be detected as the sample object corresponding to the second sample concatenating feature matched with the second target concatenating feature.

In an implementation, the concatenating feature extracting module is used to perform the feature extraction on the image data of the object to be detected, so as to obtain a target image feature; perform a feature coding on the position information of the object to be detected, so as to obtain a target position feature; and concatenate the target image feature with the target position feature, so as to obtain the first target concatenating feature.

In an implementation, the concatenating feature matching module is used to determine the second sample concatenating feature matched with the second target concatenating feature by matching the second target concatenating feature with a plurality of second sample concatenating features in parallel using a preset artificial neural network.

In an implementation, the apparatus further includes a model training module used to acquire a plurality of sample pairs, wherein: the plurality of sample pairs include a plurality of first type negative sample pairs, a plurality of second type negative sample pairs, and a plurality of positive sample pairs, the first type negative sample pair includes first sample concatenating features of two sample objects with the same signboard and having a distance greater than a preset distance threshold therebetween, the second type negative sample pair includes first sample concatenating features of two sample objects with different signboards and having a distance less than the preset distance threshold therebetween, and the positive sample pair includes first sample concatenating features of two sample objects with the same signboard and having a distance less than the preset distance threshold therebetween; select a sample pair from the plurality of sample pairs, and input first sample concatenating features of the sample pair into the deep learning model for processing, so as to obtain two second sample concatenating features corresponding to the sample pair; calculate a loss of the deep learning model based on a similarity between the two second sample concatenating features corresponding to the sample pair, and adjust a training parameter of the deep learning model according to the current loss, wherein: for the first type negative sample pairs and the second type negative sample pairs, the higher the similarity between two corresponding second sample concatenating features, the greater the loss of the deep learning model, and for the positive sample pair, the higher the similarity between two corresponding second sample concatenating features, the smaller the loss of the deep learning model; and determine whether a preset end condition is met or not, if a preset end condition is not met, select a sample pair from the plurality of sample pairs, and input two first sample concatenating features of the sample pair into the deep learning model for processing, so as to obtain two second sample concatenating features corresponding to the sample pair, and if the preset end condition is met, obtain a trained deep learning model.

According to the embodiments of the present disclosure, the present disclosure further provides an electronic device, a readable storage medium and a computer program product.

According to the embodiments of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement any method of recognizing an object in the present disclosure.

According to the embodiments of the present disclosure, a non-transitory computer-readable storage medium having computer instructions stored thereon is provided, wherein the computer instructions are configured to cause a computer to implement any method of recognizing an object in the present disclosure.

According to the embodiments of the present disclosure, a computer program product containing a computer program is provided, wherein the computer program, when executed by a processor, causes the processor to implement any method of recognizing an object in the present disclosure.

In the technical solution of the present disclosure, the collection, storage, use, processing, transmission, provision, disclosure and application of the user's personal information involved are all in compliance with the provisions of relevant laws and regulations, and necessary confidentiality measures have been taken, and it does not violate public order and good morals. In the technical solution of the present disclosure, before obtaining or collecting the user's personal information, the user's authorization or consent is obtained.

FIG. 5 shows a schematic block diagram of an exemplary electronic device 500 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 5, the electronic device 500 includes a computing unit 51 that may perform various appropriate actions and processing according to a computer program stored in a read-only memory (ROM) 52 or a computer program loaded from a storage unit 58 into a random-access memory (RAM) 53. In the RAM 53, various programs and data required for an operation of electronic device 500 may also be stored. The computing unit 51, the ROM 52 and the RAM 53 are connected to each other through a bus 54. The input/output (I/O) interface 55 is also connected to the bus 54.

A plurality of components in the electronic device 500 connected to the I/O interface 55, includes: an input unit 56, such as a keyboard, a mouse, etc.; an output unit 57, such as various types of displays, speakers, etc.; a storage unit 58, such as a magnetic disk, an optical disk, etc.; and a communication unit 59, such as a network card, a modem, a wireless communication transceiver, etc. The communication unit 59 allows the apparatus 500 to exchange information/data with other devices through computer networks such as the Internet and/or various telecommunication networks.

The computing unit 51 may be various general-purpose and/or dedicated-purpose processing components with processing and computing capabilities. Some examples of the computing unit 51 include, but are not limited to, a central processing unit (CPU), a graphics processing unit (GPU), various dedicated artificial intelligence (AI) computing chips, various computing units running machine learning model algorithms, a digital signal processor (DSP), and any appropriate processors, controllers, microcontrollers, etc. The computing unit 51 performs various methods and processing described above, such as the method of recognizing an object. For example, in some embodiments, the method of recognizing an object may be implemented as a computer software program, which is tangibly contained in a machine-readable medium, such as the storage unit 58. In some embodiments, a part of or all of the computer program may be loaded and/or installed on the apparatus 500 via the ROM 52 and/or the communication unit 59. When the computer program is loaded into the RAM 53 and executed by the computing unit 51, one or more steps of the method of recognizing an object described above may be performed. Alternatively, in other embodiments, the computing unit 51 may be configured to perform the method of recognizing an object by any other appropriate means (e.g., by means of a firmware).

Various embodiments of the systems and technologies described herein may be implemented in a digital electronic circuit system, an integrated circuit system, a field programmable gate array (FPGA), an application specific integrated circuit (ASIC), a special standard product (ASSP), a system on chip (SOC), a load programmable logic device (CPLD), a computer hardware, firmware, software and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program code for implementing the method of the present disclosure may be written in any combination of one or more programming language. The program code may be provided to a processor or controller of a general-purpose computer, a dedicated-purpose computer or other programmable data processing device, and the program code, when executed by the processor or controller, may cause the processor or controller to implement functions/operations specified in the flow chart and/or block diagram. The program code may be executed completely on a machine, partially on the machine, partially on the machine and partially on a remote machine as a separate software package, or completely on the remote machine or the server.

In the context of the present disclosure, the machine-readable medium may be a tangible medium that may contain or store a program for use by or in combination with an instruction execution system, a device or an apparatus. The machine-readable medium may be a machine-readable signal medium or a machine-readable storage medium. The machine-readable medium may include, but are not limited to, an electronic, magnetic, optical, electromagnetic, infrared, or semiconductor system, apparatus or device, or any suitable combination thereof More specific examples of machine-readable storage media may include an electrical connection based on one or more lines, a portable computer disk, a hard disk, a random access memory (RAM), a read only memory (ROM), an erasable programmable read only memory (EPROM or a flash memory), an optical fiber, a portable compact disk read only memory (CD-ROM), an optical storage device, a magnetic storage device or any suitable combination thereof.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, the server may also be a server of distributed system or a server combined with blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of recognizing an object, comprising:
acquiring a position information and an image data of an object to be detected;
performing a feature extraction on the position information and the image data of the object to be detected, so as to obtain a first target concatenating feature, and the first target concatenating feature comprising a position information feature and an image data feature of the object to be detected;
inputting the first target concatenating feature into a pre-trained deep learning model, so as to obtain a second target concatenating feature;
determining a second sample concatenating feature matched with the second target concatenating feature by matching the second target concatenating feature with each second sample concatenating feature obtained by processing a first sample concatenating feature of a sample object using the deep learning model; and
determining the object to be detected as the sample object corresponding to the second sample concatenating feature matched with the second target concatenating feature.

2. The method according to claim 1, wherein the performing a feature extraction on the position information and the image data of the object to be detected, so as to obtain a first target concatenating feature, comprising:
performing the feature extraction on the image data of the object to be detected, so as to obtain a target image feature;
performing a feature coding on the position information of the object to be detected, so as to obtain a target position feature; and
concatenating the target image feature and the target position feature, so as to obtain the first target concatenating feature.

3. The method according to claim 1, wherein the determining a second sample concatenating feature matched with the second target concatenating feature by matching the second target concatenating feature with each second sample concatenating feature comprising:
determining the second sample concatenating feature matched with the second target concatenating feature by matching the second target concatenating feature with a plurality of second sample concatenating features in parallel using a preset artificial neural network.

4. The method according to claim 1, wherein a training process of the deep learning model comprises:
acquiring a plurality of sample pairs, wherein:
the plurality of sample pairs comprise a plurality of first type negative sample pairs, a plurality of second type negative sample pairs, and a plurality of positive sample pairs,
the first type negative sample pair comprises first sample concatenating features of two sample objects with the same signboard and having a distance greater than a preset distance threshold therebetween,
the second type negative sample pair comprises first sample concatenating features of two sample objects with different signboards and having a distance less than the preset distance threshold therebetween, and
the positive sample pair comprises first sample concatenating features of two sample objects with the same signboard and having a distance less than the preset distance threshold therebetween;
selecting a sample pair from the plurality of sample pairs, and inputting first sample concatenating features of the sample pair into the deep learning model for processing, so as to obtain two second sample concatenating features corresponding to the sample pair;
calculating a loss of the deep learning model based on a similarity between the two second sample concatenating features corresponding to the sample pair, and adjusting a training parameter of the deep learning model according to the current loss, wherein:
for the first type negative sample pairs and the second type negative sample pairs, the higher the similarity between two corresponding second sample concatenating features, the greater the loss of the deep learning model, and
for the positive sample pair, the higher the similarity between two corresponding second sample concatenating features, the smaller the loss of the deep learning model; and
if a preset end condition is not met, selecting a sample pair from the plurality of sample pairs, and inputting two first sample concatenating features of the sample pair into the deep learning model for processing, so as to obtain two second sample concatenating features corresponding to the sample pair, and
if the preset end condition is met, obtaining a trained deep learning model.

5. The method according to claim 1, wherein the object to be detected is an object at a fixed position.

6. The method according to claim 5, wherein the image data of the object to be detected comprises an image containing the object to be detected, and the position information of the object to be detected comprises a longitude and a latitude of the object to be detected.

7. The method according to claim 1, wherein the performing a feature extraction on the position information and the image data of the object to be detected, so as to obtain a first target concatenating feature, comprising:
performing a joint feature extraction on the position information and the image data of the object to be detected to obtain the first target concatenating feature.

8. An electronic device, comprising:
at least one processor; and
a memory communicatively connected to the at least one processor, wherein the memory stores instructions executable by the at least one processor, and the instructions, when executed by the at least one processor, cause the at least one processor to:
acquire a position information and an image data of an object to be detected;
perform a feature extraction on the position information and the image data of the object to be detected, so as to obtain a first target concatenating feature, wherein the first target concatenating feature comprises a position information feature and an image data feature of the object to be detected;
input the first target concatenating feature into a pre-trained deep learning model, so as to obtain a second target concatenating feature;
determine a second sample concatenating feature matched with the second target concatenating feature by matching the second target concatenating feature with each second sample concatenating feature obtained by processing a first sample concatenating feature of a sample object using the deep learning model; and
determine the object to be detected as the sample object corresponding to the second sample concatenating feature matched with the second target concatenating feature.

9. The electronic device according to claim 8, wherein the at least one processor is further configured to:
perform the feature extraction on the image data of the object to be detected, so as to obtain a target image feature;
perform a feature coding on the position information of the object to be detected, so as to obtain a target position feature; and
concatenate the target image feature and the target position feature, so as to obtain the first target concatenating feature.

10. The electronic device according to claim 8, wherein the at least one processor is further configured to:
determine the second sample concatenating feature matched with the second target concatenating feature by matching the second target concatenating feature with a plurality of second sample concatenating features in parallel using a preset artificial neural network.

11. The electronic device according to claim 8, wherein the at least one processor is further configured to:
acquire a plurality of sample pairs, wherein the plurality of sample pairs comprise a plurality of first type negative sample pairs, a plurality of second type negative sample pairs, and a plurality of positive sample pairs, the first type negative sample pair comprises first sample concatenating features of two sample objects with the same signboard and having a distance greater than a preset distance threshold therebetween, the second type negative sample pair comprises first sample concatenating features of two sample objects with different signboards and having a distance less than the preset distance threshold therebetween, and the positive sample pair comprises first sample concatenating features of two sample objects with the same signboard and having a distance less than the preset distance threshold therebetween;
select a sample pair from the plurality of sample pairs, and input first sample concatenating features of the sample pair into the deep learning model for processing, so as to obtain two second sample concatenating features corresponding to the sample pair;
calculate a loss of the deep learning model based on a similarity between the two second sample concatenating features corresponding to the sample pair, and adjust a training parameter of the deep learning model according to the current loss, wherein for the first type negative sample pairs and the second type negative sample pairs, the higher the similarity between two corresponding second sample concatenating features, the greater the loss of the deep learning model, and for the positive sample pair, the higher the similarity between two corresponding second sample concatenating features, the smaller the loss of the deep learning model; and
if a preset end condition is not met, select a sample pair from the plurality of sample pairs, and input two first sample concatenating features of the sample pair into the deep learning model for processing, so as to obtain two second sample concatenating features corresponding to the sample pair, and if the preset end condition is met, obtain a trained deep learning model.

12. The electronic device according to claim 8, wherein the object to be detected is an object at a fixed position.

13. The electronic device according to claim 12, wherein the image data of the object to be detected comprises an image containing the object to be detected, and the position information of the object to be detected comprises a longitude and a latitude of the object to be detected.

14. The electronic device according to claim 8, wherein the at least one processor is further configured to:
perform a joint feature extraction on the position information and the image data of the object to be detected to obtain the first target concatenating feature.

15. A non-transitory computer-readable storage medium having computer instructions stored thereon, wherein the computer instructions are configured to cause a computer to:
acquire a position information and an image data of an object to be detected;
perform a feature extraction on the position information and the image data of the object to be detected, so as to obtain a first target concatenating feature, wherein the first target concatenating feature comprises a position information feature and an image data feature of the object to be detected;
input the first target concatenating feature into a pre-trained deep learning model, so as to obtain a second target concatenating feature;
determine a second sample concatenating feature matched with the second target concatenating feature by matching the second target concatenating feature with each second sample concatenating feature obtained by processing a first sample concatenating feature of a sample object using the deep learning model; and
determine the object to be detected as the sample object corresponding to the second sample concatenating feature matched with the second target concatenating feature.

16. The non-transitory computer-readable storage medium according to claim 15, wherein the computer instructions are further configured to cause the computer to:
perform the feature extraction on the image data of the object to be detected, so as to obtain a target image feature;
perform a feature coding on the position information of the object to be detected, so as to obtain a target position feature; and
concatenate the target image feature and the target position feature, so as to obtain the first target concatenating feature.

17. The non-transitory computer-readable storage medium according to claim 15, wherein the computer instructions are further configured to cause the computer to:
determine the second sample concatenating feature matched with the second target concatenating feature by matching the second target concatenating feature with a plurality of second sample concatenating features in parallel using a preset artificial neural network.

18. The non-transitory computer-readable storage medium according to claim 15, wherein the computer instructions are further configured to cause the computer to:
acquire a plurality of sample pairs, wherein the plurality of sample pairs comprise a plurality of first type negative sample pairs, a plurality of second type negative sample pairs, and a plurality of positive sample pairs, the first type negative sample pair comprises first sample concatenating features of two sample objects with the same signboard and having a distance greater than a preset distance threshold therebetween, the second type negative sample pair comprises first sample concatenating features of two sample objects with different signboards and having a distance less than the preset distance threshold therebetween, and the positive sample pair comprises first sample concatenating features of two sample objects with the same signboard and having a distance less than the preset distance threshold therebetween;
select a sample pair from the plurality of sample pairs, and input first sample concatenating features of the sample pair into the deep learning model for processing, so as to obtain two second sample concatenating features corresponding to the sample pair;
calculate a loss of the deep learning model based on a similarity between the two second sample concatenating features corresponding to the sample pair, and adjust a training parameter of the deep learning model according to the current loss, wherein for the first type negative sample pairs and the second type negative sample pairs, the higher the similarity between two corresponding second sample concatenating features, the greater the loss of the deep learning model, and for the positive sample pair, the higher the similarity between two corresponding second sample concatenating features, the smaller the loss of the deep learning model; and
if a preset end condition is not met, select a sample pair from the plurality of sample pairs, and input two first sample concatenating features of the sample pair into the deep learning model for processing, so as to obtain two second sample concatenating features corresponding to the sample pair, and if the preset end condition is met, obtain a trained deep learning model.

19. The non-transitory computer-readable storage medium according to claim 15, wherein the object to be detected is an object at a fixed position, and the image data of the object to be detected comprises an image containing the object to be detected, and the position information of the object to be detected comprises a longitude and a latitude of the object to be detected.

20. The non-transitory computer-readable storage medium according to claim 15, wherein the computer instructions are further configured to cause the computer to:
perform a joint feature extraction on the position information and the image data of the object to be detected to obtain the first target concatenating feature.
